(19) United States
(12) Patent Application Publication
(10) Pub. No.: US 2026/0104322 A1
(43) Pub. Date: Apr. 16, 2026

(54) METHOD AND DEVICE FOR DETERMINING A TIRE WEAR AMOUNT

(71) Applicants: HYUNDAI MOTOR COMPANY, Seoul (KR); KIA CORPORATION, Seoul (KR)

(72) Inventors: Yong Hyun Ryu, Hwaseong-si (KR); Chang Su Kim, Hwaseong-si (KR); Se Hwan Ku, Hwaseong-si (KR); Jae Wan Kwon, Hwaseong-si (KR); Jong Hyun Ahn, Hwaseong-si (KR); Yong Ki Kim, Hwaseong-si (KR); Young Sam Yoon, Hwaseong-si (KR); Go Bong Choi, Hwaseong-si (KR); Dae Un Sung, Hwaseong-si (KR); Jae Sung Cho, Hwaseong-si (KR)

(73) Assignees: HYUNDAI MOTOR COMPANY, Seoul (KR); KIA CORPORATION, Seoul (KR)

(21) Appl. No.: 19/270,104

(22) Filed: Jul. 15, 2025

(30) Foreign Application Priority Data
Oct. 14, 2024 (KR) 10-2024-0139691

(51) Int. Cl. G01M 17/02; B60C 11/24; G01G 3/14; G01G 19/08; G01G 19/44

(52) U.S. Cl. CPC G01M 17/02; B60C 11/246; G01G 3/14; G01G 19/08; G01G 19/44

(57) ABSTRACT

The present disclosure relates to a tire wear determination device and method for determining a tire wear amount based on a friction force calculated by applying an effect of a passenger load on each wheel. According to the present disclosure, a controller calculates a longitudinal friction force and a lateral friction force acting on the vehicle using data provided by a wheel speed sensor, a seat sensor, and a yaw rate sensor, and calculates an instantaneous tire wear amount by applying tire characteristic information.

### CROSS-REFERENCE TO RELATED APPLICATION

This application claims the benefit of and priority to Korean Patent Application No. 10-2024-0139691 filed on Oct. 14, 2024, which is hereby incorporated by reference as if fully set forth herein.

### BACKGROUND

### Technical Field

The present disclosure relates to a method and device for determining a tire wear amount and, more particularly, to a method and device for determining a tire wear amount based on a friction force calculated by applying an effect of a passenger load on each wheel.

### Description of Related Art

In general, vehicles are equipped with tires that allow the wheels to rotate, and the part of a tire that contacts the road surface is referred to as a “tire tread” or “tread.”

The tread, which is the ground surface of the tire, is formed of a thick layer of rubber to protect internal carcasses, brakes, and the like, and the tire ground surface has various shapes of tread marks processed thereon to secure a coefficient of friction with the road surface and maintain directionality.

The grooves of the tire tread marks are worn out due to contact with the ground (road surface) when a vehicle travels, and as the grooves are worn out, the depth of the grooves is shallower, degrading the steering and braking performance of the vehicle.

In addition, severe tire wear may cause a tire blowout while driving. Therefore, checking how much a tire of a vehicle is worn out and replacing the tire in a timely manner is important for safe driving, but checking the tire wear and life may require a driver to inspect, with their naked eyes, the wear indicator markings on a circumference of the tire.

If the driver fails to check the tire wear periodically, they may not replace the tire until it is severely worn, which may lead to a major accident due to the severely worn tire.

In addition, if the driver checks the tire with their naked eyes, they may fail to determine when to replace the tire objectively and need to check the tire wear level for each one of the wheels of the vehicle.

### SUMMARY

An object of the present disclosure is to provide a tire wear determination device and a tire wear determination method using the tire wear determination device that may determine the tire wear amount of a vehicle according to driving of the vehicle based on an effect of a passenger load on each wheel of the vehicle.

Another object of the present disclosure is to provide a tire wear determination device and a tire wear determination method using the tire wear determination device that may inform a user when to inspect and replace a tire.

According to one embodiment of the present disclosure, a device for determining a tire wear amount may include: a wheel speed sensor configured to measure a rotational speed of each wheel of a plurality of wheels of the vehicle that is driving; a seat sensor configured to detect whether each seat of a plurality of seats in the vehicle is occupied; a yaw rate sensor configured to measure a yaw rate of the vehicle, which is a criterion for determining stability of the vehicle; a memory storing tire characteristic information of various types of tires; a controller configured to determine a longitudinal friction force and a lateral friction force acting on the vehicle using data provided by the wheel speed sensor, the seat sensor, and the yaw rate sensor, and determine an instantaneous tire wear amount by applying the tire characteristic information; and a display unit configured to display the instantaneous tire wear amount.

The controller may be configured to: determine a slip ratio using a cluster speed from an instrument cluster and an actual speed measured by the wheel speed sensor; determine a per-wheel load value based on data provided by the seat sensor and initial vehicle load data; when the slip ratio exceeds a set peak slip ratio, determine the longitudinal friction force acting on the vehicle using the slip ratio and the per-wheel load value; determine the lateral friction force acting on the vehicle by applying a rotational angular velocity measured by the yaw rate sensor to the longitudinal friction force; and determine the instantaneous tire wear amount by accumulating an instantaneous driving distance onto the longitudinal friction force and the lateral friction force based on an Archard wear model.

The seat sensor may include: a weight sensing resistor disposed under each seat and having a resistance value that changes when a load is applied in a direction perpendicular to a surface of each seat; and a seatbelt sensor configured to detect whether an occupant is wearing a seatbelt on each seat.

The controller may be configured to distribute, based on data provided by the seat sensor, an effect of a weight of an occupant in each seat to each wheel.

The seat sensor may be configured to detect whether a child seat is installed and provide corresponding information to the controller, and the controller is further configured to distribute an effect of the child seat to each wheel.

The controller may be configured to: correct a cluster vehicle speed displayed through the instrument cluster by applying a linear correction method when the actual vehicle speed is less than a predetermined speed and applying a logarithmic correction method when the actual vehicle speed is greater than or equal to the predetermined speed.

The device may further include a communication unit configured to communicate with an external server by a wireless communication, through which the controller is further configured to transmit information about the instantaneous tire wear amount along with vehicle information to the external server.

According to another embodiment of the present disclosure, a method of determining a tire wear amount may include: determining a slip ratio for each wheel of a plurality of wheels of the vehicle that is traveling, using a cluster speed from an instrument cluster and an actual speed measured by a wheel speed sensor; determining a per-wheel load value to which a load of an occupant in the vehicle is applied; determining a longitudinal friction force using the slip ratio and the per-wheel load value; determining a lateral friction force acting on the vehicle by applying, to the longitudinal friction force, a rotational angular velocity measured by a yaw rate sensor; determining an instantaneous tire wear amount by accumulating an instantaneous driving distance onto the longitudinal friction force and the lateral friction force; and displaying information about the instantaneous tire wear amount in a form recognizable to a driver of the vehicle.

The per-wheel load value may be determined by distributing an effect of the weight of an occupant on each seat to each wheel based on sensing data provided by a seatbelt sensor.

The method may include correcting the cluster vehicle speed displayed through the instrument cluster by applying a linear correction when an actual vehicle speed is less than a predetermined speed and a logarithmic correction when the actual vehicle speed is greater than or equal to the predetermined speed.

The determining the instantaneous tire wear amount may include reading tire characteristic information stored in a memory in the vehicle.

The tire wear determination device and the tire wear determination method, according to embodiments of the present disclosure, may calculate a tire wear amount and notify a driver of the tire wear amount, thereby relieving the driver of the need for having to inspect the tires of their vehicle with their naked eyes and protecting the safety of the driver.

### BRIEF DESCRIPTION OF THE DRAWINGS

FIG. 1 is a block diagram illustrating an example configuration of a tire wear determination device according to one embodiment of the present disclosure.

FIG. 2 is a diagram illustrating an example configuration of a seat sensor according to one embodiment of the present disclosure.

FIG. 3 is a flow diagram illustrating a tire wear determination method according to one embodiment of the present disclosure.

FIG. 4 is a flow diagram illustrating a process of calculating a slip ratio in a tire wear determination method according to one embodiment of the present disclosure.

FIG. 5 is a graph illustrating a difference between an actual vehicle speed and a corrected cluster speed.

FIG. 6 is a flow diagram illustrating a process of calculating a corrected cluster speed in a tire wear determination method according to one embodiment of the present disclosure.

FIG. 7 is a flow diagram illustrating a process of calculating a longitudinal friction force in a tire wear determination method according to one embodiment of the present disclosure.

FIG. 8 is a graph illustrating a relationship between a longitudinal friction force and a peak slip ratio.

FIG. 9 is a flow diagram illustrating a process of calculating a lateral friction force in a tire wear determination method according to one embodiment of the present disclosure.

### DETAILED DESCRIPTION

The following structural or functional descriptions of example embodiments are merely intended for the purpose of describing the embodiments and the embodiments may be implemented in various forms.

The embodiments are not construed as limited to the disclosure and should be understood to include all changes, modifications, equivalents, and replacements within the idea and the technical scope of the disclosure.

Although terms including ordinal numbers, such as, “first,” “second,” and the like, may be used herein to describe various elements, the elements are not limited by these terms. These terms are only used to distinguish one element from another. For example, a first element may be referred to as a second component, and similarly the second element may be referred as the first element, without departing from the scope of the present disclosure.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween. Similarly, when an element is described as being “disposed on” another element, the element may be directly on the surface of the other element or disposed above the surface of the other element with some space therebetween. When a part, component, unit, device, element, or the like of the present disclosure is described as having a purpose or performing an operation, function, or the like, the part, component, unit, device, or element should be considered herein as being “configured to” meet that purpose or to perform that operation or function.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the sequences of operations or steps described herein are merely examples, and are not limited to those set forth herein, but may be changed as should be apparent after an understanding of the disclosure of this application, with the exception of operations or steps necessarily occurring in a certain order. Also, descriptions of features that are known after an understanding of the disclosure of this application may be omitted for increased clarity and conciseness.

A “vehicle” described herein may include an internal combustion engine vehicle having an engine as a power source, a hybrid electric vehicle having an engine and an electric motor as a power source, an electric vehicle having an electric motor as a power source, a fuel cell vehicle, and the like.

Hereinafter, a device for determining a tire wear amount (or simply a “tire wear determination device”) and a method of determining a tire wear amount (or simply a “tire wear determination method”), according to embodiments of the present disclosure, are described with reference to the accompanying drawings.

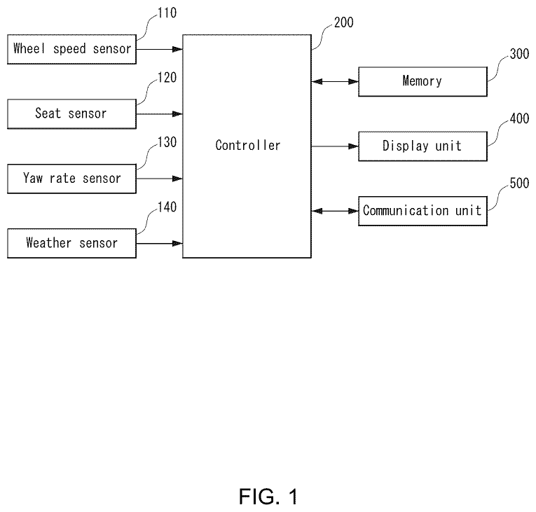

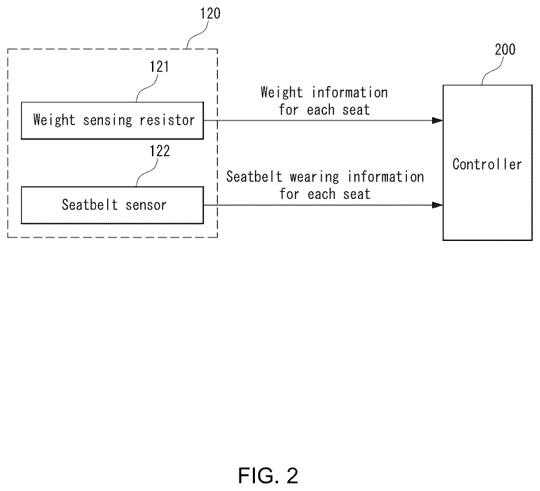

FIG. 1 is a block diagram illustrating an example configuration of a tire wear determination device according to one embodiment of the present disclosure. FIG. 2 is a diagram illustrating an example configuration of a seat sensor according to one embodiment of the present disclosure.

As shown, the tire wear determination device may include a plurality of sensors 110 to 140, a controller 200, a memory 300, a display unit 400, and a communication unit 500 that performs data communication with the controller 200. Although some of the various sensors are shown, the sensors are not limited to the ones shown in FIG. 1, but other sensors such as a brake sensor, a gyro sensor, a tire pressure sensor, a road surface condition sensor, and the like may be added to calculate a tire wear amount by the controller 200.

A wheel speed sensor 110 may measure a rotational speed of each wheel of a vehicle that is traveling and transfer (i.e., by sending a signal) the measured rotational speed to the controller 200.

A seat sensor 120 may provide the controller 200 with information about whether a seat is occupied by an occupant of the vehicle and the weight of the occupant. As shown in FIG. 2, the seat sensor 120 may include a weight sensing resistor 121 disposed under each seat to measure the weight of the occupant, and a seatbelt sensor 122 installed on each seat to sense whether the seat is occupied. Although the weight sensing resistor 121 and the seatbelt sensor 122 are both shown as being included, the tire wear determination device may also be implemented only with either configuration alone. For example, the weight sensing resistor 121 may be disposed under each seat to extract weight information of the occupant along with seat information. In a case where only the seatbelt sensor 122 is included, the weight of the occupant may be averaged and generalized to assume the weight as 70 kilograms (kg). The seat sensor 120 may detect whether a child seat is installed and provide corresponding information to the controller 200.

A yaw rate sensor 130 may measure a yaw rate, which is a criterion for determining the stability of the vehicle, and may provide the measured yaw rate to the controller 200.

A weather sensor 140 may transfer information about the temperature or humidity outside the vehicle to the controller 200. In general, the braking distance of the vehicle may be determined by the weight of the vehicle, the friction force between the road surface and the tires, the braking speed, the friction resistance coefficient, and road environment such as road surface conditions.

Based on data provided by the sensors 110 to 140, the controller 200 may calculate an instantaneous tire wear amount that is based on the driving, slip ratio, braking, and the like of the vehicle, in consideration of factors such as the weight of the vehicle and the braking performance of the vehicle. The controller 200 may further consider the road surface conditions based on the temperature and humidity measured by the weather sensor 140 to calculate the slip ratio and the braking distance of the vehicle. The controller 200 may calculate the braking distance of the vehicle based on the road surface conditions, for example, whether the road surface is wet or icy due to rain or snow. For example, based on a braking distance of 10 meters (m) on a dry road surface, the controller 200 may further consider a road surface condition (e.g., a wet road surface due to rain) and calculate a braking distance based on a predetermined correction factor for such a wet road surface, and calculate a tire wear amount accordingly. The controller 200 may also use the information provided by the seat sensor 120 to distribute the effect on each wheel based on whether a child seat is installed.

The memory 300 may store therein various parameter information required to calculate a tire wear amount, including tire characteristic information about various types of tires. The display unit 400 may display the instantaneous tire wear amount calculated according to a control signal provided by the controller 200 in a form recognizable to a driver of the vehicle. The communication unit 500 may wirelessly connect to an external data network, such as the Internet, to acquire information about a road on which the vehicle is traveling and provide the road information to the controller 200. The controller 200 may transmit the information about the calculated instantaneous tire wear amount, along with vehicle information, to an external server via the communication unit 500.

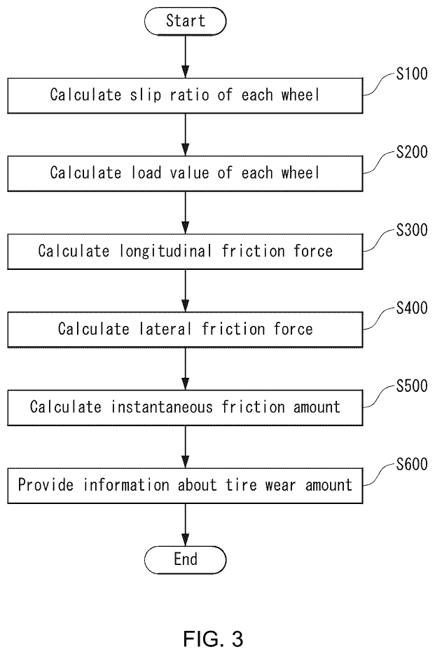

FIG. 3 is a flow diagram illustrating a tire wear determination method according to one embodiment of the present disclosure. An entity that performs the following operations of the tire wear determination method may be the controller 200 shown in FIG. 1. In other words, the controller 200 may calculate an instantaneous tire wear amount based on data provided by each sensor and provide information about a tire wear amount to the driver in real time.

The controller 200 may calculate a slip ratio for each wheel of the vehicle that is traveling using a corrected cluster speed displayed through a cluster and an actual speed measured by the wheel speed sensor 110, in step S100. The controller 200 may calculate a load on each wheel by combining seatbelt status data and an initial load of the vehicle, in step S200. The controller 200 may calculate a longitudinal friction force using the slip ratio and a per-wheel load value, in step S300. The controller 200 may calculate a lateral friction force acting on the vehicle by applying a rotational angular velocity measured by the yaw rate sensor 130 to the longitudinal friction force, in step S400. The controller 200 may calculate an instantaneous tire wear amount by accumulating an instantaneous driving distance onto the longitudinal friction force and the lateral friction force, in step S500. The controller 200 may provide information about the calculated instantaneous tire wear amount in a form recognizable to the driver, in step S600.

Specifically, when the vehicle is operating or braking, there may be a slip between the tires of the vehicle and the road surface. This slip of the vehicle may wear down the tires. As the tires become more worn, the friction force between the tires and the road surface may be reduced. This reduced friction force, i.e., the worn tires, may cause more slips. As a result, the tires may be worn further. Such tire wear may cause damage to the tires themselves, such as a flat tire, and may also adversely affect the braking performance of the vehicle. The less the tires are worn, the greater the magnitude of the friction force between the tires and the road surface. The vehicle may thus experience fewer slips, and the slip ratio may occupy a smaller percentage of the speed of the vehicle.

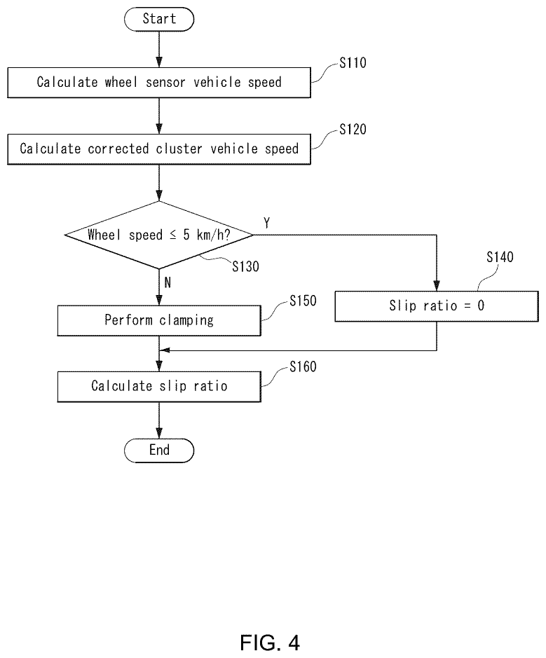

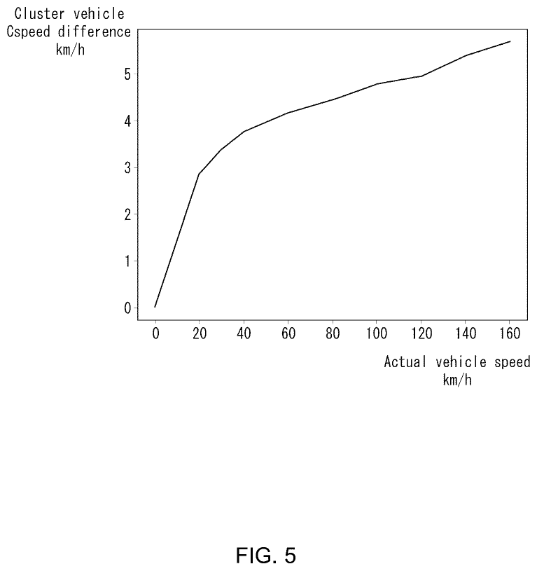

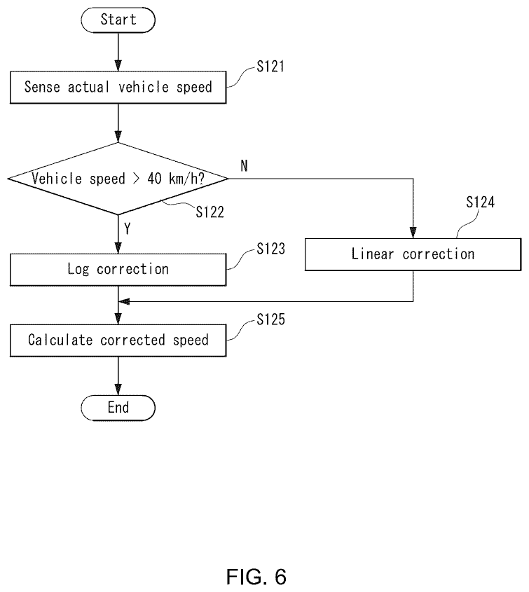

The process by which the controller 200 calculates the slip ratio of the vehicle is described with reference to FIG. 4. When the vehicle is traveling, the controller 200 may calculate a wheel sensor-based vehicle speed based on a speed at which a wheel is rotating from the wheel speed sensor 110, in step S110. The vehicle speed detected by the wheel speed sensor 110 may be corrected and transmitted to a speedometer or odometer of a meter cluster, in step S120. In this case, the vehicle speed detected by the wheel speed sensor 110 and the vehicle speed displayed by the meter cluster may have a difference as shown in the graph of FIG. 5. It may be verified that, as the speed of the vehicle increases, the difference between the actual vehicle speed and the speed displayed by the cluster increases. This may indicate that a process is performed to correct the vehicle speed output by the cluster. A process of calculating a corrected cluster vehicle speed is described with reference to FIG. 6. The controller 200 may calculate a wheel speed through the wheel speed sensor 110, in step S121. The controller 200 may determine whether the actual vehicle speed is greater than 40 kilometers per hour (km/h), in step S122. The controller 200 may apply a linear correction method when the actual vehicle speed is less than 40 km/h, in step S124. When the actual speed is greater than or equal to 40 km/h, the controller 200 may apply a logarithmic correction method in step S123 to calculate the corrected cluster vehicle speed displayed through the cluster in step S125.

Referring back to FIG. 4, the controller 200 may determine whether the wheel speed is 5 km/h or less in step S130. When the vehicle speed detected by the wheel speed sensor 110 is 5 km/h or less, the slip ratio may be processed as “0” in step S140. When the vehicle speed detected by the wheel speed sensor 110 is greater than 5 km/h, the slip ratio of the vehicle may be calculated by performing clamping with a value between −1 and +1 in step S150.

Although the wheel speed may be acquired directly from a wheel speed sensor 110 provided on each wheel, the vehicle speed may be difficult to measure directly from the sensors. Therefore, the vehicle speed may be approximated by a value of the wheel speed that has the largest value among the wheel speeds of all the wheels. In general, the slip ratio may be a value that indicates the degree of slip between the tire and the road surface, which may be expressed as a percentage of the difference between the wheel speed (e.g., angular velocity and rotational volume) of a reference wheel and the wheel speed (e.g., angular velocity and rotational volume) of a measured wheel, as shown in <Equation 1>below.

Slip ratio=(vehicle speed−wheel speed)/vehicle speed×100 <Equation 1>

To show how well the tire is sliding on the road surface, the slip ratio may be calculated by acquiring the speed (e.g., the vehicle speed) at which the vehicle is traveling on the road and the speed (e.g., a tire speed indicated by speed symbol) at which the tire tread is moving and by dividing their difference by the speed at which the vehicle is traveling on the road.

For example, in a case where the vehicle is traveling at 30 km/h and the tires are rolling, with no driving or braking force applied, the slip ratio may be calculated to be “0,” with the calculation of “(30 km/h of road surface travel−30 km/h of tire tread movement)/30 km/h of road surface travel.” In other words, in this case, there is no slip between the tires and the road surface (although there are actual partial slips, the sum thereof may be considered “0” due to their different directions).

In another example, in a case where the tires are sliding in a state where the rotation is stopped (locked) by the full brake while the vehicle is traveling at the same speed of 30 km/h, the slip ratio may be calculated to be “1” because the movement speed of the tire tread (i.e., the tire speed) is 0 in that case, with the calculation of “(30 km/h of the road surface travel speed−0 km/h of the tire tread movement speed)/30 km/h of the road surface travel speed.”

In a case where the tires are actually rolling with the brakes applied, barely slipping without being locked, the slip ratio may be a value between 0 and 1. For example, in a case where the vehicle is traveling at 30 km/h, and the tires are rolling at 27 km/h of the tire tread movement speed (i.e., the tire speed) slowed down due to the brakes, the slip ratio may be a value of “(30−27)/30=0.1” in such a case.

The slip ratio may be generally multiplied by 100 and expressed as a percentage, which may also be referred to as a slip percentage. For example, when the slip ratio is 0.1, then the slip percentage may be 10%, as shown in step S160.

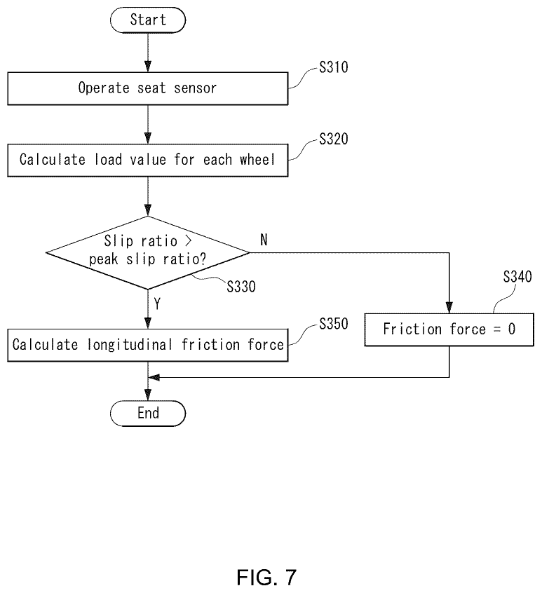

FIG. 7 is a flow diagram illustrating a process in which the controller 200 calculates a longitudinal friction force in a tire wear determination method according to one embodiment of the present disclosure. The controller 200 may receive a motion signal from the seat sensor 120 to calculate a per-wheel load value to which a passenger load, which is a load of an occupant in the vehicle, is applied in step S310. The controller 200 may calculate a load on each wheel by combining seatbelt status data and an initial load of the vehicle in step S320. The controller 200 may determine which seat is occupied by an occupant based on information provided by the seat sensor 120, i.e., the seatbelt sensor 122. Depending on the occupied seat, a ratio of an axial load on each wheel is as shown in Table 1 below. In this case, if the seats are not equipped with the weight sensing resistor 121, the controller 200 may assume that an occupant's weight is 70 kg.

TABLE 1

| | FL | FR | RL | RR |
|---|---|---|---|---|
| Driver seat | 0.4 | 0.2 | 0.3 | 0.1 |
| Passenger seat | 0.2 | 0.4 | 0.1 | 0.3 |
| Rear center seat | 0.15 | 0.15 | 0.35 | 0.35 |
| Rear left seat | 0.2 | 0.1 | 0.5 | 0.2 |
| Rear right seat | 0.1 | 0.2 | 0.2 | 0.5 |

For example, since a person occupying the driver's seat weighs 70 kg, the controller 200 may calculate the load as follows: a load of 28 kg, which is 0.4 of 70 kg, is distributed and affects the front left wheel (FL); a load of 14 kg, which is 0.2 of 70 kg, is distributed and affects the front right wheel (FR); a load of 21 kg, which is 0.3 of 70 kg, is distributed and affects the rear left wheel (RL); and a load of 7 kg, which is 0.1 of 70 kg, is distributed and affects the rear right wheel (RR).

When an occupant is seated on the passenger's seat, the controller 200 may determine that the loads corresponding to 14 kg, 28 kg, 7 kg, and 21 kg, which are 0.2, 0.4, 0.1, and 0.3 of 70 kg, respectively, affect the respective wheels (FL, FR, RL, and RR). When an occupant is seated on the center of the rear seat, the controller 200 may determine that the loads corresponding to 10.5 kg, 10.5 kg, 24.5 kg, and 24.5 kg, which are 0.15, 0.15, 0.35, and 0.35 of 70 kg, respectively, affect the respective wheels (FL, FR, RL, and RR). When an occupant is seated on the rear left seat, the controller 200 may determine that the loads corresponding to 14 kg, 7 kg, 35 kg, and 14 kg, which are 0.2, 0.1, 0.5, and 0.2 of 70 kg, respectively, affect the respective wheels (FL, FR, RL, and RR). When an occupant is seated on the rear right seat, the controller 200 may determine that the loads corresponding to 7 kg, 14 kg, 14 kg, and 35 kg, which are 0.1, 0.2, 0.2, and 0.5 of 70 kg, respectively, affect the respective wheels (FL, FR, RL, and RR). In other words, it may be verified that the effect on each wheel is proportional to a distance from a position of an occupant in the vehicle.

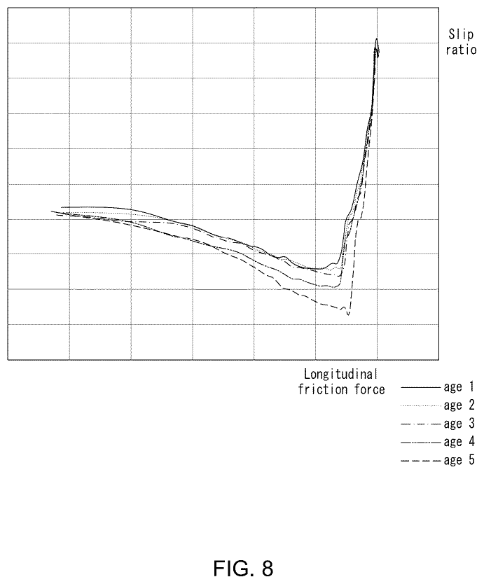

After calculating the load value affecting each wheel, the controller 200 may calculate the longitudinal friction force. FIG. 8 is a graph illustrating a relationship between a longitudinal friction force and a peak slip ratio. As shown, it may be verified that the peak slip ratio of each tire increases over time after a tire is mounted. The x-axis represents a slip ratio, and the y-axis represents a longitudinal friction force. The solid line (Age 1) represents a peak slip ratio of a new tire, and the dashed line (Age 5) represents a peak slip ratio of an oldest tire. A contact area (or tread area) may increase as the tire wears, and a support stiffness may increase as a tread height decreases, which may increase a maximum friction force (or peak friction force).

Referring back to FIG. 7, the controller 200 may compare the slip ratio of each wheel and the peak slip ratio of the tire mounted on each wheel in step S330. When the slip ratio is less than or equal to the peak slip ratio, the controller 200 may determine that the friction force is “zero (0).” When the slip ratio is greater than the peak slip ratio, the controller 200 may calculate the longitudinal friction force (or longitudinal sliding (or skid) force) acting on each wheel of the vehicle based on the slip ratio and the load value in step S350.

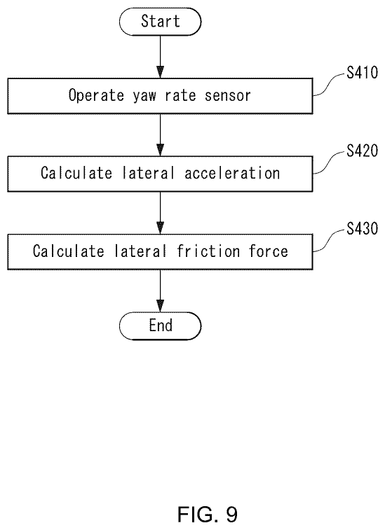

FIG. 9 is a flow diagram illustrating a process of calculating a lateral friction force in a tire wear determination method according to one embodiment of the present disclosure. The controller 200 may receive a rotational angular velocity (or yaw rate) from the yaw rate sensor 130 in step S410. The yaw rate sensor 130, which is a sensor configured to detect a rotational angular velocity of a vehicle in a direction of a vertical axis of the vehicle, may be used for controlling steering of the vehicle. It may be formed as an integral type of piezoelectric ceramic with a vibrator and a detector reversed by 90 degrees (°). When an alternating voltage is applied to the vibrator, deformation may occur and vibration may be generated, which may cause the vibrator to swing left and right with a constant frequency. In this state, when the vehicle turns at a certain angular velocity, the sensor's detector may be tilted at right angles to the direction of vibration by the Coriolis force, and the alternating voltage may be output. By detecting an alternating current (AC) waveform generated by the detector, the direction and magnitude of the turning may be detected and output as an analog signal. The controller 200 may calculate a lateral acceleration using the rotational angular velocity in step S420. The controller 200 may calculate a lateral friction force using the lateral acceleration in step S430. The lateral friction force may refer to a coefficient of lateral skid friction, which indicates the degree to which a vertical force acting on the pavement is converted into a lateral friction force generated between the tire and the pavement when the vehicle travels over a planar curve. The coefficient of lateral skid friction may depend on the speed of the vehicle, the shapes and conditions of the tire and the pavement. The coefficient of lateral skid friction has the following characteristics: a value of the coefficient of lateral skid friction decreases as the speed increases; a value of the coefficient of lateral skid friction decreases on a wet and icy pavement; and a value of the coefficient of lateral skid friction decreases depending on the degree of tire wear.

Based on an Archard Model, the controller 200 may calculate an instantaneous tire wear amount by accumulating an instantaneous driving distance onto the longitudinal friction force and the lateral friction force. Based on a predetermined unit distance, the controller 200 may calculate an accumulated distance by accumulating a currently calculated instantaneous tire wear amount to an immediately preceding unit distance value, and may calculate the instantaneous tire wear amount for that accumulated distance.

The controller 200 may calculate the tire wear amount using tire information stored in the memory 300. The memory 300 may store information about the inch or size of the tire, a difference in wear performance according to a manufacturer (e.g., material difference information), and the like. The data to be stored may be set as a representative value. The controller 200 may apply the information stored in the memory 300 to an Archard coefficient and to a contact patch and material hardness, which are basic information of the target tire. Before this, the controller 200 may set an optimal value to predict the tire wear amount of a tire mounted on an actual vehicle through multiple tests.

As described above, the tire wear determination device and the tire wear determination method, according to embodiments of the present disclosure, may determine a tire wear amount from driving of a vehicle based on the effect of a passenger load on each wheel and may inform a user when to inspect and replace a tire, thereby relieving the driver of having to inspect the tire of the vehicle with their naked eyes and protecting the safety of the driver.

While various embodiments of the present disclosure have been shown and described above, the present disclosure is not limited to the specific embodiments described above, various changes and modifications may be made by one of ordinary skill in the art to which the present disclosure pertains without departing from the spirit and scope of the disclosure, and such changes and modifications should not be construed as being independent of the technical ideas or views of the present disclosure.

What is claimed is:

1. A device for determining a tire wear amount for a vehicle, the device comprising:
a wheel speed sensor configured to measure a rotational speed of each wheel of a plurality of wheels of the vehicle that is traveling;
a seat sensor configured to detect whether each seat of a plurality of seats in the vehicle is occupied;
a yaw rate sensor configured to measure a yaw rate of the vehicle, the yaw rate being a criterion for determining stability of the vehicle;
a memory configured to store tire characteristic information of various types of tires;
a controller configured to determine a longitudinal friction force and a lateral friction force acting on the vehicle using data provided by the wheel speed sensor, the seat sensor, and the yaw rate sensor, and determine a tire wear amount based on the tire characteristic information; and
a display unit configured to display information based on the tire wear amount.

2. The device of claim 1, wherein the controller is further configured to:
determine a slip ratio using a cluster speed from an instrument cluster and an actual speed measured by the wheel speed sensor;
determine a per-wheel load value based on data provided by the seat sensor and initial vehicle load data;
determine, based on the slip ratio exceeding a set peak slip ratio, the longitudinal friction force acting on the vehicle using the slip ratio and the per-wheel load value;
determine the lateral friction force acting on the vehicle by applying a rotational angular velocity measured by the yaw rate sensor to the longitudinal friction force; and
determine the tire wear amount by accumulating a driving distance onto the longitudinal friction force and the lateral friction force based on an Archard wear model.

3. The device of claim 2, wherein the seat sensor comprises:
a weight sensing resistor disposed under each seat and having a resistance value that changes when a load is applied in a direction perpendicular to a surface of each seat; and
a seatbelt sensor configured to detect whether an occupant is wearing a seatbelt on each seat.

4. The device of claim 3, wherein the controller is further configured to:
distribute, based on data provided by the seat sensor, an effect of a weight of an occupant in each seat to each wheel.

5. The device of claim 4, wherein the seat sensor is further configured to detect whether a child seat is installed and provide corresponding information to the controller, and wherein the controller is further configured to distribute an effect of the child seat to each wheel.

6. The device of claim 2, wherein the controller is further configured to:
correct a cluster vehicle speed displayed through the instrument cluster by applying a linear correction method when the actual vehicle speed is less than a predetermined speed and applying a logarithmic correction method when the actual vehicle speed is greater than or equal to the predetermined speed.

7. The device of claim 1, further comprising:
a communication unit configured to communicate with an external server by a wireless communication, through which the controller is further configured to transmit information about the tire wear amount along with vehicle information to the external server.

8. A method of determining a tire wear amount for a vehicle, the method comprising:
determining a slip ratio for each wheel of a plurality of wheels of the vehicle that is traveling, using a cluster speed from an instrument cluster and an actual speed measured by a wheel speed sensor;
determining a per-wheel load value to which a load of an occupant in the vehicle is applied;
determining a longitudinal friction force using the slip ratio and the per-wheel load value;
determining a lateral friction force acting on the vehicle by applying, to the longitudinal friction force, a rotational angular velocity measured by a yaw rate sensor;
determining a tire wear amount by accumulating a driving distance onto the longitudinal friction force and the lateral friction force; and
displaying information about the tire wear amount in a form recognizable to a driver of the vehicle.

9. The method of claim 8, wherein the per-wheel load value is determined by distributing an effect of a weight of an occupant on each seat to each wheel based on sensing data provided by a seatbelt sensor.

10. The method of claim 8, further comprising:
correcting the cluster vehicle speed displayed through the instrument cluster by applying a linear correction when an actual vehicle speed is less than a predetermined speed and a logarithmic correction when the actual vehicle speed is greater than or equal to the predetermined speed.

11. The method of claim 8, wherein determining the tire wear amount comprises:
acquiring tire characteristic information stored in a memory in the vehicle.
